(19) United States
(12) Patent Application Publication
(10) Pub. No.: US 2026/0307273 A1
(43) Pub. Date: Oct. 8, 2026

(54) PICKING MODULE

(71) Applicant: VELEC SYSTEMS, Wattrelos (FR)

(72) Inventors: Florian GHESTEM, Lille (FR); Ludovic Lalet, Villeneuve D'ascq (FR); Martin Lauridant, Lille (FI)

(21) Appl. No.: 19/638,770

(22) Filed: Apr. 3, 2026

(30) Foreign Application Priority Data
Apr. 4, 2025 (FR) FR2503543

(51) Int. Cl. B25J 15/00; B25J 15/04; B25J 15/06; B33Y 80/00

(52) U.S. Cl. CPC B25J 15/0061; B25J 15/0441; B25J 15/0616; B33Y 80/00

(57) ABSTRACT

A picking module for a modular picking assembly. The picking module comprises a support and one or more lugs projecting from the support. Each lug is made jointly with the support and suited for removable attachment of a respective suction cup. At least one internal channel formed in the support and at least one part of the one or more lugs. The internal channel opens near one or more upstream openings located on the support and each configured for having a fluid connection with a respective aspiration conduit and near several downstream openings located at the end of a corresponding lug.

### TECHNICAL FIELD

The present description relates to a picking module, especially for picking slender objects in the food and agriculture field. The present description also relates to a modular picking assembly comprising such a picking module.

### PRIOR ART

In the industrial production sector, automation revolutionized processes for handling and packaging products, specifically in the food and agriculture industry. Picking, or pick and place, devices play an important role in this conversion. These devices are designed for effectively selecting, sorting and moving merchandise, thus easing the movement of food products from a bulk state to their final arrangement in packages. With their ability to perform repetitive manipulations at high speed, these devices serve not only to increase productivity, but also to reduce the painfulness of the tasks for human operators. By incorporating articulated robotic arms and advanced picking systems, picking devices provide a precise and rapid handling of the products, thus responding to the rigorous requirements of the food and agriculture industry safely and effectively.

Among these devices, as can be seen in FIG. 1, a modular picking assembly 100 is known that comprises a frame 101 comprising longitudinal rails on which are slidably mounted a plurality of picking modules 103, one after the other and parallel to each other. The main frame 101 is provided with at least one actuator, configured for sliding the plurality of picking modules 103 along the rails 102.

According to an embodiment that is known and shown in FIG. 2, a picking module 103 comprises a support 104 slidably mounted on the rails 102. There are also suction cups 105 for grasping and handling objects. Each suction cup 105 is connected to a respective aspiration conduit, by a respective pneumatic connector 106, which provides both a mechanical and fluid connection between the suction cup 105 and the aspiration conduit. These pneumatic connectors 106 are additionally structurally independent of the support 104 and securely fixed to the support 104, thus guaranteeing the secure connection of the suction cups 105 to the support 104.

This picking module 103, although modular, is made up of a significant number of separate parts, which have several constraints. During assembly or disassembly, the multiplicity of components may complicate and extend the process, requiring specific attention for guaranteeing correct and secured mounting. Additionally, cleaning these parts is an essential task, especially in the food and agriculture industry where hygiene is fundamental. The presence of numerous parts increases the risk of residue retention, making cleaning more laborious and demanding rigorous methods for assuring compliance with sanitary standards. These constraints may impact operational effectiveness and maintenance of the picking module 103.

Further, in a modular picking assembly 100 comprising a large number of picking modules 103, the bulk of the conduits and the excessive intricacy thereof may prove problematic.

### DISCLOSURE

A picking module for a modular picking assembly is proposed, where the picking module comprises:
a support;
one or more lugs projecting from the support, where each lug is made jointly with the support and suited for removable attachment of a respective suction cup;
at least one internal channel formed in the support and at least one part of said one or more lugs, where said internal channel opens:
   near one or more upstream openings located on the support and each configured for having a fluid connection with a respective aspiration conduit; and
   near one or more downstream openings located at the end of a corresponding lug.

The internal channel may comprise:
a main conduit opening near said one or more upstream openings; and
one or more secondary conduits with a fluid connection with the main conduit and each opening near one respective downstream opening.

Said one or more lugs may be distributed along a longitudinal direction of the picking module, where the main conduit of the internal channel comprises at least one distribution branch extending longitudinally along said one or more lugs and through which the main conduit has a fluid connection with said one or more secondary conduits.

Said one or more upstream openings may comprise a single upstream opening.

The picking module may comprise one or more guiding members secured to the support, where each guiding member is configured for engaging with at least one respective rail in order to slidably guide the picking module on the rail (42).

At least one, or even each, of said one or more guiding members may comprise a guiding fork which has a slit-shaped opening which allows the insertion and withdrawal of the rail in a tubular extension formed by the guiding fork, where the guiding fork is suited for holding the rail in the tubular extension by clipping effect.

According to another aspect, a modular picking assembly is proposed comprising a frame which comprises one or more rails extending along an axial direction and one or more picking modules such as described above, where each picking module is slidably mounted on said one or more rails.

The picking modules may be coupled pairwise so as to slide together on said one or more rails between a holding configuration and a placement configuration.

The modular picking assembly may comprise one or more connectors which each comprise an inlet with a fluid connection with a vacuum source and a plurality of outlets. Each outlet of each connector may have a fluid connection through an aspiration conduit with an associated upstream opening among said one or more upstream openings of an associated picking module among said one or more picking modules.

Each connector may be configured for providing an identical fluid path between the vacuum source and each upstream opening associated with one of said one or more outlets of the connector.

### BRIEF DESCRIPTION OF THE DRAWINGS

Other characteristics, details and advantages will appear upon reading the following detailed description and upon analysis of the attached drawings, on which:

FIG. 1 is a side view of a modular picking assembly according to the known state-of-the-art.

FIG. 2 is a perspective view of a picking module according to the known state-of-the-art.

FIG. 3 is a perspective view of a picking module according to a first variant of the present description.

FIG. 4 is a section view of a picking module according to the first variant.

FIG. 5 is a perspective view of a picking module according to a second variant of the present description.

FIG. 6 is a front view of the picking module according to the second variant.

FIG. 7 is a top view of the picking module according to the second variant.

FIG. 8 is a section view of a picking module according to the second variant.

FIG. 9 is a perspective view of a picking module according to a third variant of the present description.

FIG. 10 is a section view of a picking module according to the third variant.

FIG. 11 is a perspective view of a picking module according to a fourth variant of the present description.

FIG. 12 is a section view of a picking module according to the fourth variant.

FIG. 13 is a perspective view of a modular picking assembly according to the present description in a holding configuration.

FIG. 14 is a partial perspective view of the modular picking assembly from FIG. 13.

FIG. 15 is a perspective view of a modular picking assembly according to the present description in a placement configuration.

FIG. 16 is a partial perspective view of the modular picking assembly from FIG. 13.

FIG. 17 is a partial top view of the modular picking assembly from FIG. 13.

FIG. 18 is a larger scale view of the dotted zone from FIG. 17.

FIG. 19 is a perspective view of a connector from the modular picking assembly from FIG. 13.

FIG. 20 is another perspective view of a connector from the modular picking assembly from FIG. 13.

FIG. 21 is a perspective view of a picking module according to yet another variant of the present description.

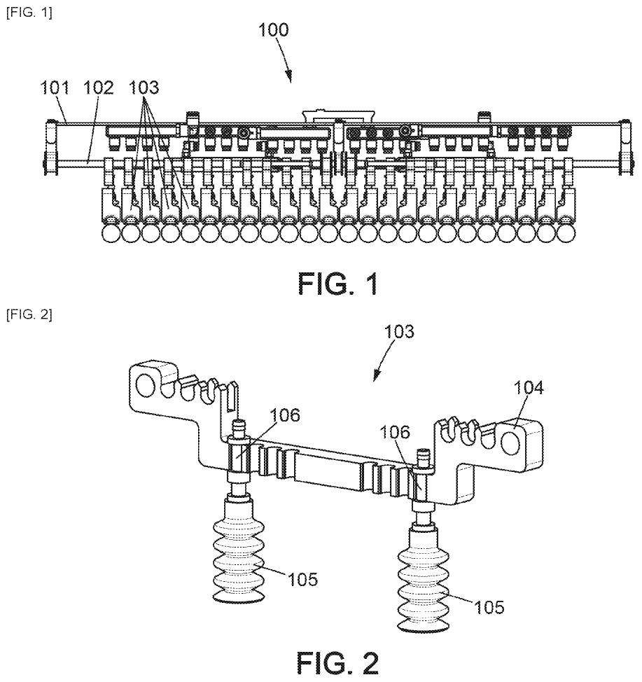

### DESCRIPTION OF EMBODIMENTS

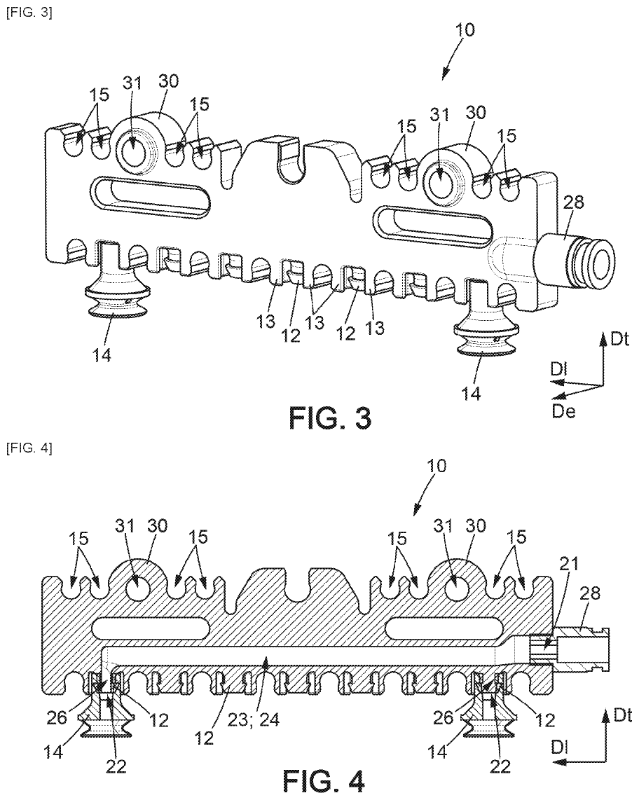

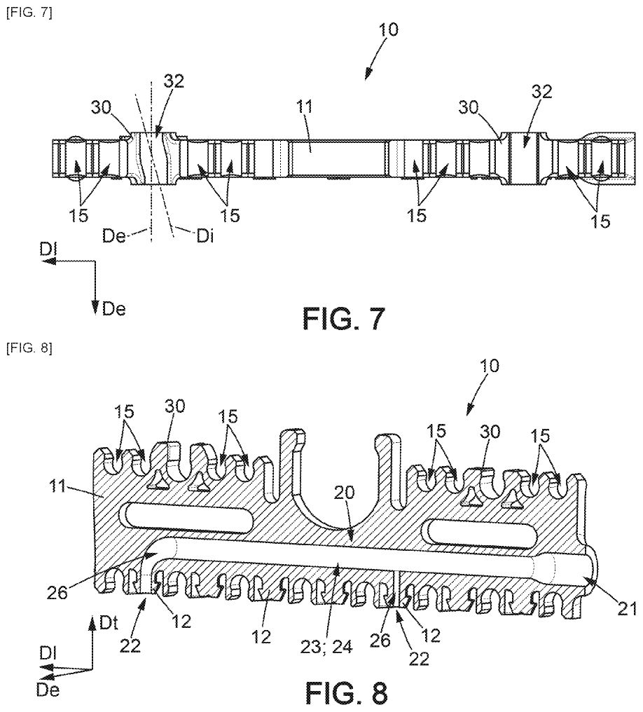

First, a picking module is described for a modular picking assembly (described in more detail later), with reference to FIGS. 3 to 12.

The picking module 10 comprises a support 11. A longitudinal direction Dl which coincides with the direction of the largest dimension of the support and a transverse direction Dt coinciding with the direction of the second-largest dimension of the support may be defined. The transverse direction may be perpendicular to the longitudinal direction. The support may have a substantially flat shape having a reduced thickness relative to the longitudinal Dl and transverse Dt direction. A thickness dimension De perpendicular to the longitudinal Dl and transverse Dt directions is defined.

In the following description, when referring to qualifiers of absolute position, such as the terms “front,” “rear,” “upper,” “lower,” etc., or to qualifiers of orientation, such as “horizontal,” “vertical,” etc., reference is made to the orientation of the figures or of the picking module in its normal position of use in holding or placement configuration (described later) unless otherwise stated.

The gripping module comprises one or more lugs 12 projecting from the support 11, where each lug 12 is made jointly with the support 11 and suited for removable attachment of a respective suction cup 14. Each lug 12 may project from the support 11 along the transverse direction Dt. The end of the lug 12 is understood to mean the free end of the lug 12, meaning the end opposite the support 11. Said one or more lugs 12 may be distributed along the longitudinal direction Dl of the picking module 10.

“Made jointly with” is understood to mean that the support 11 and the lugs 12 form a unitary part.

Each lug 12 may have a cylindrical, conical or frustoconical shape. Also each lug 12 may have a teat shape. Each lug 12 may comprise at least one among a locking rim, a throat and a boss.

The picking module 10 may comprise a suction cup 14 fixed removably on each lug 12 whose end comprises a downstream opening 22. Each suction cup 14 may be attached to the corresponding lug 12 by clicking, especially on said at least among the annular locking rim (case shown), the throat, and the boss. Alternatively or additionally, each suction cup 14 may be attached on the lug 12 by crimping, meaning by an elastic deformation of the suction cup 14 around the corresponding lug 12. For this purpose, each section, 14 may comprise an attachment tip. According to an implementation variant, each suction cup 14 may be attached on the corresponding lug 12 by screwing, in particular by the attachment tip comprising internal threading. For this purpose, each lug 12 may be threaded. The lug 12 provides an effective and secured hold of the suction cup 14 on the support 11, while allowing an easy attachment of the suction cup 14 on the support 11.

Each suction cup 14 may comprise a flexible membrane, forming bellows, so as to adapt to and to be well in contact with the curved surfaces of a product to be grasped. The suction cup 14 is thus configured for grasping, in particular along the transverse direction Dt, by aspiration during a reduced pressure in the internal channel 20. The gripping module 10 may be adapted to gripping a slender object. The slender object may be a food product, for example a sausage (of animal or vegetable origin).

Remarkably, the picking module comprises at least one internal channel 20 formed in the support 11 and in at least one part of said one or more lugs 12. It is understood that the internal channel 20 is immersed in the support 11 and in at least one part of said one or more lugs 12. The internal channel 20 opens near one or more upstream openings 21 located on the support 11 and each configured for having a fluid connection with a respective aspiration conduit, and near one or more downstream openings 22 located at the end of a corresponding lug 12.

The picking module 10 thus has a reduced number of components. The reduction of the number of parts in the picking module 10 has a significant technical advantage, especially by the elimination of the structurally independent pneumatic connectors 70. In fact, the known pneumatic connectors 70 are replaced here by the internal channel 20. By directly incorporating the lugs 12 on the support 11, the module considerably simplifies the assembly and disassembly processes. This simplification reduces not only the time and effort required to mount and dismount the module, but it also reduces the risk of installation errors. Further, with fewer separate parts, cleaning of the module becomes easier and more effective, which is particularly beneficial in environments where hygiene is crucial, as in the food and agriculture industry. This optimized design contributes to improving operational effectiveness and to maintaining high sanitary standards.

Further, a reduction of the mass of the picking module 10 is obtained. A reduced mass makes movement of the module by a robot easier, allowing faster and more precise movements. This lightness also reduces the inertia of the system, which improves the responsiveness of the robot during changes of direction or speed. Further, a reduced total mass contributes to operational safety, because it reduces the potential impact forces in case of collision or failure.

Such a picking module 10 may be obtained by additive manufacturing. Also, such a gripping module 10 may be made of plastic.

The number of downstream openings 22 may be less than the number of lugs 12. Expressed differently, the internal channel 20 might not open near at least one lug 12 among said one or more lugs 12. In this meaning, the end of at least one lug 12 among said one or more lugs 12 may be solid. Said one or more downstream openings 22 may comprise at least two downstream openings 22. Said at least two downstream openings 22 may be arranged symmetrically about a median plane of the support 11 perpendicular to the longitudinal direction Dl. Alternatively said at least two downstream openings 22 may be arranged asymmetrically about a median plane of the support 11 perpendicularly to the longitudinal direction Dl. Consequently, the picking module 10 may comprise at least two suction cups 14.

The picking module 10 may be manufactured without a downstream opening 22 and at least two downstream openings 22 may be opened before the first use of the picking module 10. Thus, the position of the downstream openings 22 may be adapted on the first use of the picking model 10. Supplemental downstream openings 22 may later be added to the picking module 10 if more downstream openings 22 are necessary for the implementation of a second use. In this configuration, the picking module 10 may be easily adapted to several distinct uses requiring different numbers and/or positions of downstream openings.

In another configuration, the picking module 10 may be manufactured directly with at least two downstream openings 22.

For at least one, even each, of said one or more lugs 12, the picking module 10 may comprise at least one protuberance 13 which surrounds all or part of said lug 12. Each lug 13 may project from the support 11 along the transverse direction Dt. Said at least one protuberance 13 may comprise a pair of protuberance 13 arranged, especially longitudinally, on either side of the corresponding lug 12. Each protuberance 13 may have a rounded surface facing the lug 12 shaped to correspond to the suction cup 14. In this meaning, each protuberance 13 may form a half-shell partially surrounding the corresponding lug 12. The space between the lug 12 and each protuberance 13 is suited to receive a suction cup 14, in particular, an attachment portion of the suction cup 14. In other words, the protuberances 13 with their rounded surface oriented towards the lug 12 are shaped for adapting to the suction cup 14 thus forming a half-shell which partially surrounds the lug 12. The picking module 10 is thus designed to provide effective protection of the lugs 12 which is particularly crucial when a hole is made, because they then have a thinner wall thickness. This configuration protects the lugs 12 from impacts and external forces, preserving their structural integrity despite the reduced wall. By providing a space between the lug 12 and each protuberance 13 for receiving the suction cup 14 (especially the attachment tip), the module keeps the picking functionality while also reinforcing the durability and reliability of the lugs 12 in demanding industrial environments.

As will be seen later, the internal channel 20 of the picking module 10 may be intended to have a fluid connection with a vacuum source via one or more aspiration conduits. The picking module 10 may comprise one or more connecting sleeves 28. Each connecting sleeve 28 may be located near an upstream opening 21 among said one or more respective upstream openings 21. Each sleeve may be configured for providing a sealed and secure connection between the internal channel 20 and an aspiration conduit. At least one, even each, of said one or more sleeves may be configured for a connection with a nozzle of the aspiration conduit. At least one, even each, a said one or more sleeves may be of the quick-connect connector type. At least one, even each, of said one or more sleeves may be made jointly with the support. At least one, even each, of said one or more sleeves may be added to and attached to the support.

The internal channel 20 may comprise a main conduit 23 opening near said one or more upstream openings 21. The internal channel 20 may also comprise one or more secondary conduits 26 with a fluid connection with the main conduit 23 and each opening near one respective downstream opening 22.

Each secondary conduit 26 of the internal channel 20 may have a hole made as a function of the specific needs, meaning solely in the lugs 12 which will actually receive a suction cup 14. This characteristic confers modularity to the picking module 10 with which to easily adapt to the varied requirements of grasping goods. By making holes in the necessary conduits, the module may be configured to adapt the position of the suction cups 14 as a function of the size, shape or arrangement of the objects to be handled. This flexibility improves the effectiveness of the system and allows quick and economical customization for various industrial applications. Further, the picking module 10 may be designed as a standard component, which can be used in a wide variety of applications, which simplifies the production and makes it more economical.

At least one, even each, of said one or more secondary conduits 26 may extend in whole or in part along the transverse direction Dt. At least one, even each, of said one or more secondary conduits 26 may be in whole or in part a cylinder of revolution along the transverse direction Dt.

The main conduit 23 of the internal channel 20 may comprise at least one distribution branch 24 extending longitudinally along said one or more lugs 12 and through which the main conduit 23 has a fluid connection with said one or more secondary conduits 26. The distribution branch 24 therefore provides the distribution of the vacuum in each secondary conduit 26 for the picking operation.

Referring to the variants from FIGS. 3 to 8, said one or more upstream openings 21 may comprise a single upstream opening 21. The use of a single aspiration conduit connected to the picking module 10 again further reduces the number of parts needed. This reduces not only the complexity of the picking module 10, but also the intricacy of the conduits within the modular picking assembly 40. Consequently, the system becomes easier to manage and maintain. Fewer conduits also means a reduction of the risks of leaks or malfunctions, thus contributing to more reliable performance and simplified maintenance.

The distribution branch 24 of the main conduit 23 may open directly near the single upstream opening 21. In other words, the opening end of the distribution branch 24 coincides with the upstream opening 21. Specifically, the distribution branch 24 of the main conduit 23e may open longitudinally near the upstream opening 21.

Said one or more downstream openings 22 may comprise at least one downstream opening 22 located at the end of the lug 12 which is the farthest longitudinally from the upstream opening 21 (called distal downstream opening 22 hereafter). The bottom end of the distribution branch 24, meaning the end opposite the upstream opening 21, may have a fluid connection with the secondary conduit 26 opening near the distal opening. This serves to avoid the formation of a bottom portion without outlet in the distribution branch 24 and minimizes the risk of retaining cleaning liquid residues. This is particularly important for maintaining hygiene, because residues may become centers of contamination. By eliminating zones where liquid could stagnate, the picking module 10 guarantees a cleaning that is more effective and compliant with sanitary standards. The secondary conduit 26 opening near the distal opening may extend transversely and be curved so as to be connected to the distribution branch 24.

Said one or more secondary conduits 26 may comprise at least one first secondary conduit 26 and one second secondary conduit 26, where the first secondary conduit 26 is located longitudinally closer to the upstream opening 21 than is the second secondary conduit 26. The first secondary conduit 26 may have a smaller section than a section of the second secondary conduit 26. More particularly, the first secondary conduit 26 may have a smaller inner diameter than an inner diameter of the second secondary conduit 26. Generally, in the case of a plurality of secondary conduits 26, a section or an inner diameter of each secondary conduit 26 may be as much larger as the secondary conduit 26 is longitudinally farther from the upstream opening 21. This configuration allows a homogeneous aspiration through the various secondary conduits 26 while considering losses of head due to different aspiration lengths.

The distribution branch 24 may have, at least in part, a longitudinal profile which flares longitudinally, preferably progressively, in a direction going from the opening end towards the bottom end. The distribution branch 24, by having a longitudinal profile which flares progressively from the opening end towards the bottom end, serves to reduce the loss of head in the distribution branch 24. Consequently, the effectiveness of the aspiration system is improved, guaranteeing that each suction cup 14 receives an optimal aspiration. This reduction of losses of head contributes to a more reliable and constant performance of the picking module 10. Alternatively the distribution branch 24 may have, at least in part, a straight longitudinal profile. In other words, the distribution branch 24 may have a shape of a cylinder of revolution about a longitudinal axis.

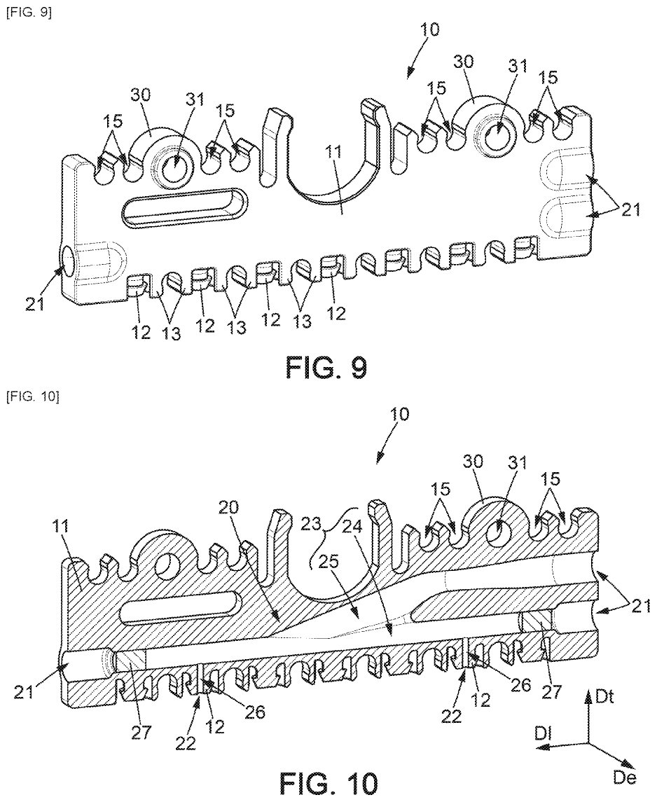

According to another variant shown in FIGS. 9 and 10 and in which said one or more upstream openings 21 also comprise a single upstream opening 21, the main conduit 23 may comprise an aspiration branch 25 which opens longitudinally near the upstream opening 21 and which has a fluid connection with the distribution branch 24. The distribution branch 24 may then be blind at each of its longitudinal ends. In other words, each longitudinal end of the distribution branch 24 may be blocked, definitively or temporarily. For example, each longitudinal end of the distribution branch 24 may be blocked by means of a removable plug 27.

In particular, the longitudinal position of each plug 27 may be determined according to the longitudinal position of the lugs 12 whose end comprises a downstream opening 22. This configuration may be designed for limiting the loss of head difference between the various aspiration paths each opening by a respective downstream opening 22. By adjusting the longitudinal position of the lugs 27, the system may balance the aspiration flow, thus assuring a uniform distribution of the pressure through the various conduits. This guarantees that each suction cup 14 receives an optimal aspiration, thus improving the effectiveness and the performance of the picking module 10 in its handling operations. Longitudinal position of the plug 27 is understood to mean the longitudinal position which defines the distribution branch 24, meaning the longitudinal position of the corresponding longitudinal end of the distribution branch 24. The plug 27 may have a thickness along the longitudinal direction Dl.

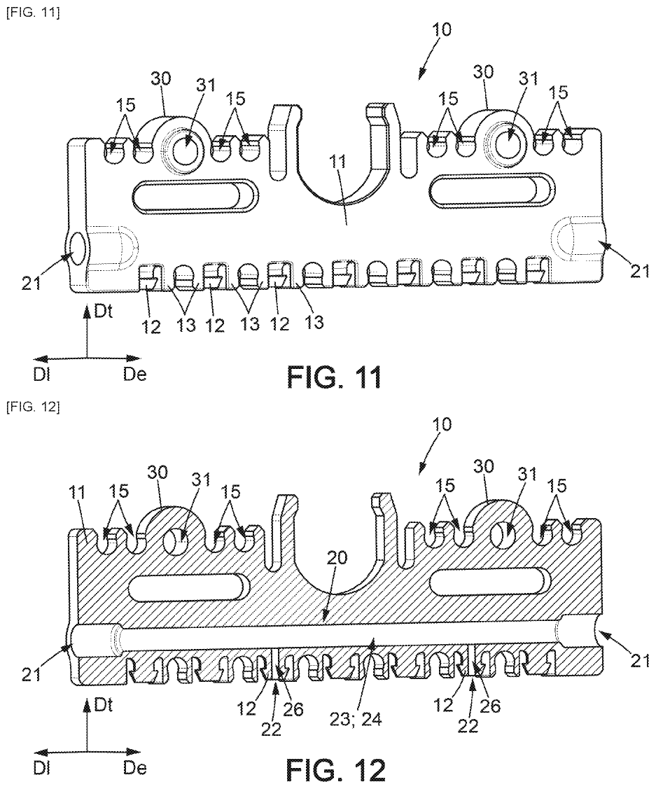

According to an implementation variant shown in FIGS. 11 and 12, said one or more upstream openings 21 may comprise a first upstream opening 21 and a second upstream opening 21. The distribution branch 24 of the main conduit 23e may open directly longitudinally from each side near the first upstream opening 21 and near the second upstream opening 21. In this meaning, the first upstream opening 21 and the second upstream opening 21 may be longitudinally opposite from each other. Specifically, the first upstream opening 21 and the second upstream opening 21 may be located on surfaces of the support 11 longitudinally opposite from each other. This configuration allows a homogeneous aspiration through the various secondary conduits 26 while making the losses of head uniform for the secondary conduits 26.

The picking module may comprise one or more guiding members 30 secured to the support 11, where each guiding member 30 is configured for engaging with one respective rail 42 in order to slidably guide the picking module 10 on the rail(s) 42. Thus, the support 11 may be slidably mounted on one or more rails 42.

Each guiding member 30 may be configured for engaging with the respective rail 42 in order to guide the module while sliding along the thickness direction De of the picking module 10. The thickness direction De may be perpendicular to at least one among the longitudinal direction Dl and the transverse direction Dt.

Each guiding member 30 may be made jointly (meaning unitary) with the support 11.

At least one, even each, of said one or more guiding members 30 may project from the support 11 along the transverse direction Dt. Specifically said one or more lugs 12 and said one or more guiding members 30 may project from the support 11 along the transverse direction Dt. The support 11 may have a lower edge and an upper edge opposite from each other along the transverse direction Dt. Said one or more lugs 12 may project from the lower edge of the support 11. Said one or more guiding members 30 may project from the upper edge of the support 11. Alternatively, at least one, even each, of said one or more guiding members 30 may be formed in the support 11.

Said one or more guiding members 30 may comprise a first guiding member 30 and a second guiding member 30. The first guiding member 30 and the second guiding member 30 may be separated longitudinally from each other.

At least one, even each of the guiding members 30, may comprise an orifice allowing passage of the rail 42, thus providing a hold and a guided movement of the picking module 10. The orifice may have a circular or oblong section. Thus, the guiding member 30 may form a tubular extension 31, thus forming a sleeve, along the thickness direction De intended to receive the corresponding rail 42. The guiding member 30 may comprise an inner surface which delimits the tubular extension 31, and near which the guiding member 30 may be implemented of a material with a low coefficient of friction, in order to reduce wear and make movement on the corresponding rail 42 easier.

As can be seen in FIGS. 3 and 4, for example, at least one, even each, of said one or more guiding members 30 may comprise a guiding ring (or closed guiding ring) allowing a complete engagement around the rail 42. This type of guiding member 30 provides a permanent hold on the rail 42 limiting any accidental release.

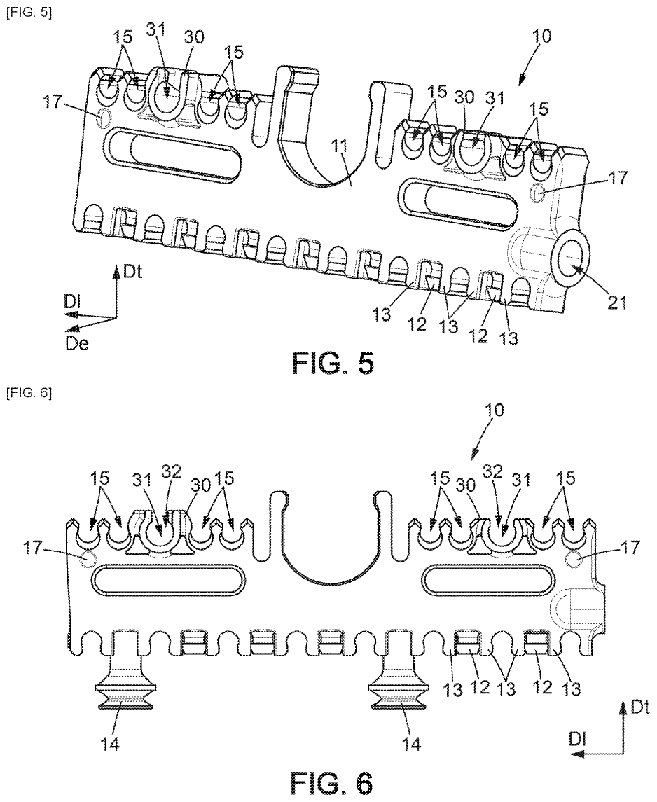

As can be seen in FIGS. 5 to 8, at least one, even each, of said one or more guiding members 30 may comprise a guiding fork (or open guiding ring) which has a slit-shaped opening 32 which allows the insertion or withdrawal of the rail 42 in the tubular extension 31 without having to slide it to one end of the rail 42 and therefore without having to remove other picking modules 10. The slit 32 of at least one, even each, of said one or more guiding members 30 may extend along the thickness direction De to make insertion or withdrawal of the rail 42 easier. What's more, the slit 32 of at least one, even each, of said one or more guiding members 30 may extend along an inclined direction Di forming an angle with respect to the thickness direction De, specifically in a plane defined by the thickness direction De and the longitudinal direction Dl. The misalignment between the tubular extension 31 along the thickness direction De and the slit 32 along the inclined direction Di allows an insertion with clipping of the rail 42 into the guiding fork, which provides a better hold of the rail 42 in the guiding fork.

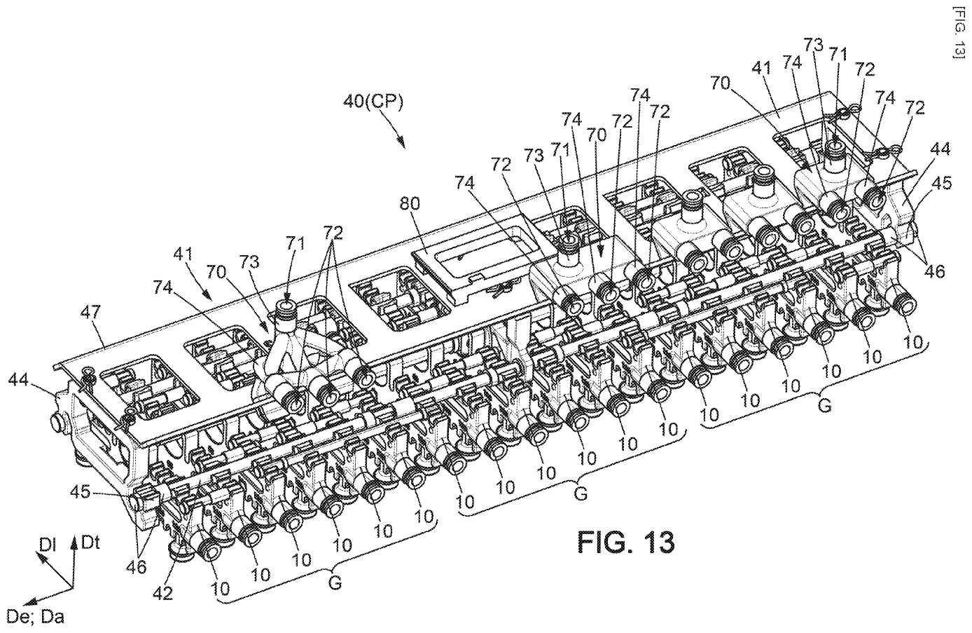

A modular picking assembly is now described with reference to FIGS. 13 to 20. The modular picking assembly 40 may comprise a frame 41 which comprises one or more rails 42 extending along an axial direction Da. Said one more rails may be parallel to each other. In the present case, the frame 41 comprises two rails 42 in the example shown.

The frame 41 may comprise at least one cross piece 44 to which is connected at least one end portion of each rail 42. The end portion of the rail 42 may be connected by clipping (meaning by elastic nesting) to the cross piece 44. For this purpose, the cross piece 44 may comprise elastically deformable reliefs 45 for the clipping of the rail 42. Further, the end portion of the rail 42 may comprise a pair of shoulders 46 between which is attached, preferably with a reduced play and even without play, the cross piece 44, especially, via the reliefs 45. A relative movement along the axial direction Da between the rail 42 in the crosspiece 44 is thus blocked.

As shown, the frame 41 may comprise two cross pieces separated from each other along the axial direction Da. Thus, for each rail 42, a first end portion may be attached to one of the cross pieces 44 and a second opposite end portion may be attached to the other crosspiece 44.

The frame 41 may also comprise a chassis 47. Each cross piece 44 may be attached to the chassis 47, especially according to at least one of the attachment techniques: schooling, riveting, welding, adhering, nesting, elastic nesting (meaning clipping), soldering, crimping and attachment by pin.

The modular picking assembly 40 may also comprise one or more picking modules 10 such as described above.

Said one or more picking modules 10 may be laid out parallel to each other. In this meaning, said one or more picking modules 10 may be arranged such that their longitudinal directions Dl are coincident. The axial direction Da of the modular picking assembly 40 may coincide with the thickness direction De of said one or more picking modules 10.

At least one of said one or more picking modules 10 may be slidably mounted on each of said one or more rails 42. The modular picking assembly 40 may comprise one or more groups G of picking modules 10. Within each group, at least one picking module 10 (in the present case one or two) may be fixed on said one or more rails 42, where the others are slidably mounted on said one or more rails 42.

For the fixed mounting of a picking module 10 on a rail 42, the rail 42 may comprise a pair of shoulders 43 between which the picking module 10 is inserted along the axial direction Da (particularly with reduced play or without play). Thus, blocking sliding along the axial direction Da of the picking module 10 on the rail 42 is provided. By using a pair of shoulders on the rail for inserting the picking module, the system simplifies the process of installation and attachment. This method reduces the complexity of the mounting by eliminating the need for additional components such as pins, which reduces the risk of mechanical failure and makes maintenance easier.

The modular picking assembly 40 may comprise at least one actuator 50 configured for driving said one or more picking modules 10 in translation along said one or more rails 42. Said at least one actuator 50 may be an axial cylinder (for example pneumatic, electric or hydraulic). The cylinder may comprise a piston 51 and a retractable rod 52 fixedly connected to at least one of said one or more picking modules 10.

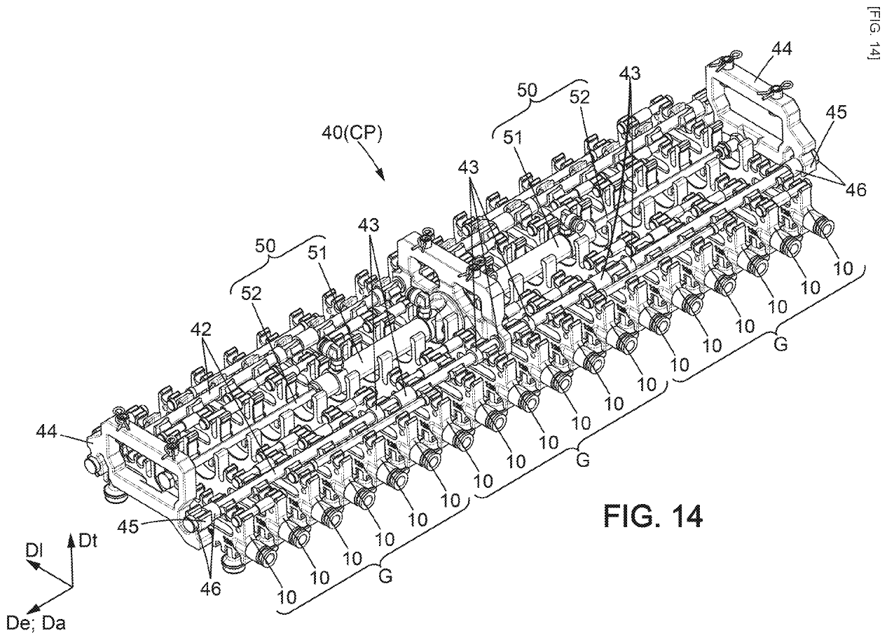

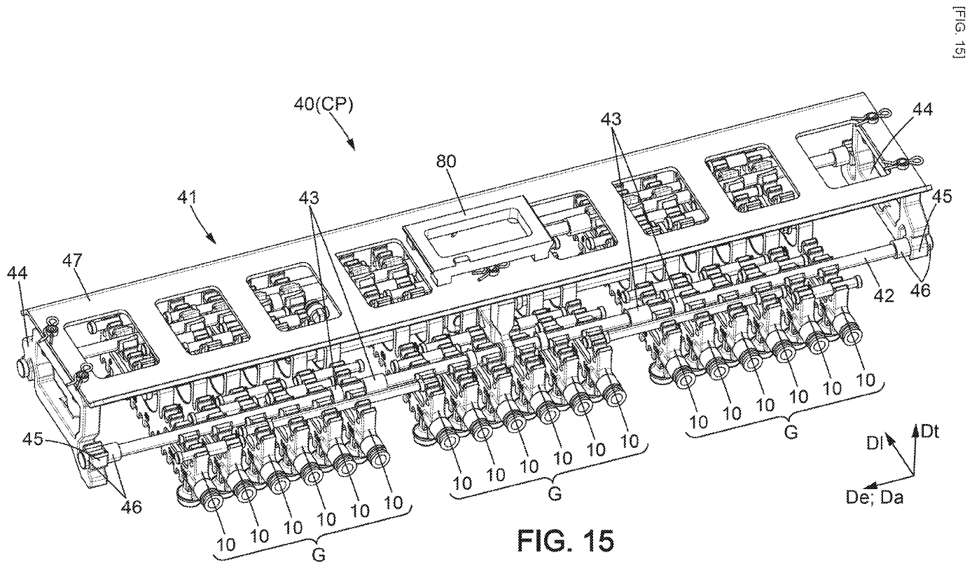

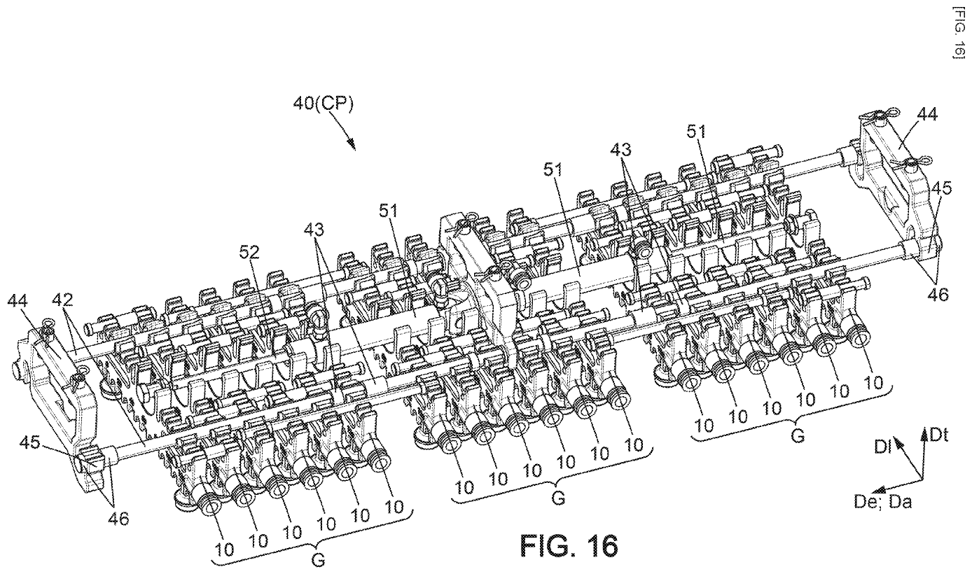

The picking modules 10 may slide on said one or more rails 42 between a holding configuration CP (FIGS. 13 and 14) and a placement configuration CD (FIGS. 15 and 16).

In the holding configuration CP, the picking modules 10 are evenly distributed (meaning uniformly) along the axial direction Da. In other words, the picking modules 10 of each consecutive pair of picking modules 10 are axially separated from each other according to a first identical spacing.

In the placement configuration CD, the picking modules 10 are organized (meaning distributed) by groups along the axial direction Da. The picking modules 10 of a single group G may be distributed uniformly along the axial direction Da. The picking modules 10 of each consecutive pair of picking modules 10 of a single group G may be axially separated from each other according to a second spacing. The groups G of picking modules 10 may be separated longitudinally from each other according to a third spacing. Expressed differently, a first picking module 10 located at the end of the first group G may be axially separated from a second axially consecutive picking module 10 (consecutive from the first picking module 10) and located at the end of a second group G by the third spacing. The third spacing may be greater than the second spacing.

The picking modules 10 may slide together between the holding configuration CP and the placement configuration CD.

When the picking modules 10 are in the holding configuration CP, the modular picking assembly 40 is able to pick one or more slender objects placed on a support surface 11. Each slender object may be grasped by an associated picking module 10 with contact of said one or more suction cups 14 on the slender object and placed under reduced pressure (even under vacuum) from the internal channel 20 by the vacuum source. The support surface 11 may be configured for routing said slender products. For example, the support surface 11 may be a conveyor belt, having parallel housings in relief, individually receiving the slender products.

When the picking modules 10 are in the placement configuration CD, the modular picking assembly 40 is suited for placing the slender objects in one or more packages by stopping the low pressure (even connecting to free air) in the internal channel 20.

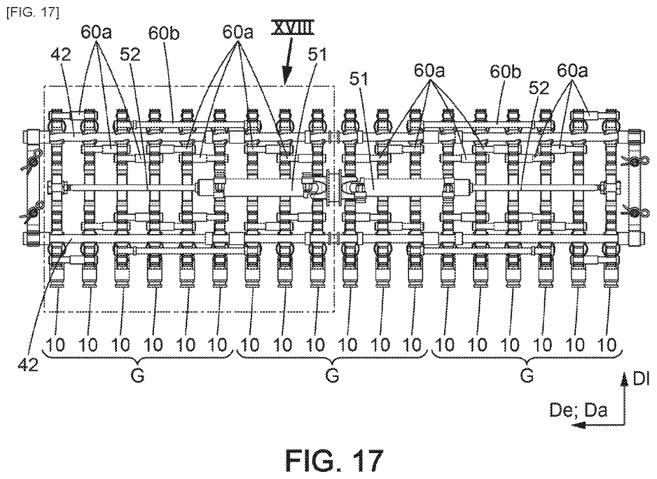

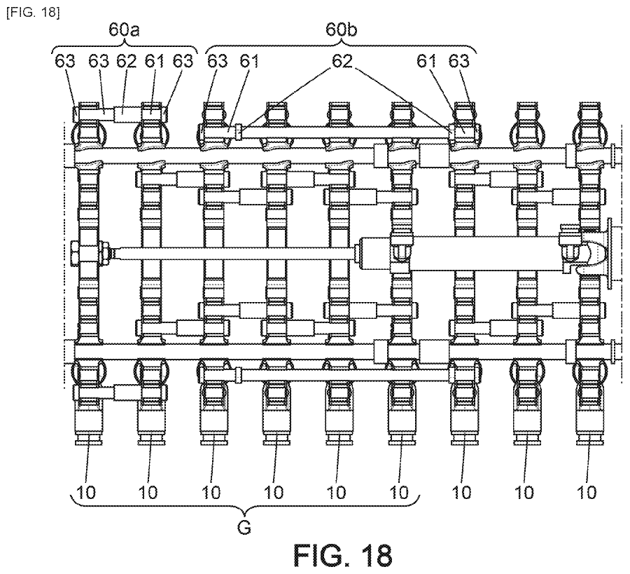

The module and picking assembly 40 may comprise a plurality of connecting rods 60a, 60b each configured for coupling to picking modules 10 among said one or more picking modules 10. The connecting rods 60a, 60b are more specifically visible in FIGS. 17 and 18. The connecting rods 60a and 60b may engage by two ends in two respective housings 15 of the picking modules 10 by elastic nesting. The housings 15 of each picking module 10 may be formed in the upper edge of the picking module 10, in particular aligned along the longitudinal direction, again especially placed symmetrically about a median plane of the picking module 10 perpendicular to their longitudinal direction Dl. In the example shown, each picking module 10 comprises eight housings 15, especially four housings 15 on each side of the median plane of the picking module 10.

The connecting rods 60a, 60b may be slender elements along the axial direction Da. The connecting rods 60a, 60b may comprise at least two thin portions 61 of smaller radius, on each of which a respective picking module 10 may be attached, even slide, by the corresponding housing 15. The connecting rods 60a, 60b may comprise at least one thick portion 62 of larger radius, on which the picking modules 10 may not slide. The thick portion 62 may axially separate the two thin portions 61. The ends of the connecting rod 60a, 60b are each provided with a stop 63. One of the picking modules 10 may be mounted without axial play on one of the thin portions 61 of the connecting rod 60a, 60b (between the thin portion 62 and one of the stops 63) and the other of the picking modules 10 may be slidably mounted (meaning with play) on the other thin portion 61 of the connecting rod 60a, 60b (between the thick portion 62 and the other of the stops 63). This slidable mounting allows adjustment of the spacing between the paired picking modules 10, in particular between the holding configuration CP and the placement configuration CD. For this purpose, one of the thin portions 61 may be longer than the other. The length of the thin portion 61 on which a picking module 10 is slidably mounted (between the stop 63 and the thick portion 62) determines the range of movement between the two picking modules 10 connected pairwise by the connecting rod 60a, 60b.

The connecting rods 60a, 60b may comprise short connecting rods 60a. The short connecting rods 60a keep the picking modules 10 connected to each other within a single group G. With this meaning, each short connecting rod 60a provides a connection between two successive picking modules 10 of a single group G. One or more, even all, of the picking modules 10 of each group G of picking modules 10 may be connected pairwise by removable connecting rods 60a, 60b.

Each actuator 50 may be connected to a single picking module 10 among said one or more picking modules 10. More specifically, each actuator 50 may be connected to a single picking module 10 among said one or more picking modules 10 within a single group G. The pairwise coupling of the connecting modules from each group G combined with the slidable mounting on the connecting rods 60a, 60b allows an adjustment of the spacing between the picking modules 10 within a single group G one after the other (once a picking module 10 has completed its translation, it drives the following module in translation, and so on) by the activation of a single actuator 50.

The connecting rods 60a, 60b may comprise long connecting rods 60a. Each long connecting rod 60b is positioned between two groups G of picking modules 10. One picking module 10 from each of the two picking-module 10 groups G is fixed to the long connecting rod 60B, by elastic nesting, by its housing 15. The long connecting rods 60b provide a sliding connection between two picking modules 10 from two successive groups G, along the rails 42, allowing two picking modules 10 to approach each other in the holding position, and a separation between the two groups along a range limited and set by the long connecting rod 60b, fixing the spacing of the two groups G, in the placement position. Further, the long connecting rods 60b allow an adjustment of the spacing between the picking modules 10 within two groups G, one after the other, and by the activation of a single actuator 50.

A picking module 10 may therefore be connected to one, even two, picking modules 10 within the same group G by respective short connecting rods 60a and possibly to a picking module 10 from another group G by a long connecting rod 60b. The coupling between two picking modules 10 may be implemented by a pair of connecting rod 60a, 60b (short or long), especially arranged symmetrically about a median plane of the picking modules 10 and perpendicular to the longitudinal direction Dl.

According to the implementation example, a first, a second and a third group G of picking modules 10 can be successively provided, each comprising, for example, 6 picking modules 10. A first actuator 50 can be provided for sliding a picking module 10 from the first group G and a second actuator 50 provided for sliding a picking module 10 from the third group G. The picking modules 10 of the first group G may be connected pairwise by short connecting rods 60a. Similarly, the picking modules 10 of the first group G may be connected pairwise by short connecting rods 60a. Thus, the activation of the first actuator 50 and the second actuator 50 (in this case the translation of the corresponding retractable rod 52) allows the respective transition of the picking modules 10 of the first group G and the second group G between the holding configuration CP and the placement configuration CD. The second group G of picking modules 10 may comprise a first subgroup G and a second subgroup G of picking module 10 for each of which the picking modules 10 are connected pairwise by short connecting rods 60a. In other words, the picking modules 10 of the first subgroup G are not connected to the picking modules 10 of the second subgroup G. A first long connecting rod 60b connecting a picking module 10 from the first group G to a picking module 10 from the first subgroup G of the second group G may be provided so that the activation of the first actuator 50 allows the transition of the modules from the first subgroup G between the holding configuration CP and the placement configuration CD. Similarly, a second long connecting rod 60b connecting a picking module 10 from the third group G to a picking module 10 from the second subgroup G of the second group G may be provided so that the activation of the second actuator 50 allows the transition of the modules from the second subgroup G between the holding configuration CP and the placement configuration CD.

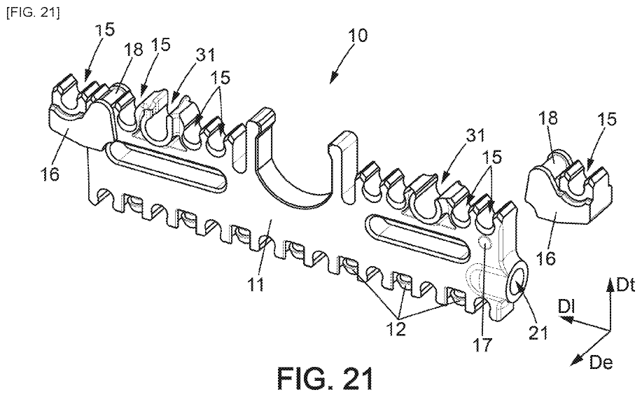

At least two of said one or more picking modules 10 may comprise at least one extension block 16 removably added to the support 11 and forming an additional housing 15 longitudinally offset from the support 11. The extension block may be added along the longitudinal direction from the picking module 10, especially near a longitudinal end of the support 11. Such an extension block 16 can be seen in FIG. 21 in which a picking module 10 comprises an extension block 16 added near each longitudinal end of the support 11. This additional housing 15 allows the coupling of said two picking modules 10 by a connecting rod 60a, 60b positioned longitudinally offset from the support 11 of the picking modules 10. This serves to increase the number of groups G of picking modules 10 for example four, five or more without increasing the number of actuators 50. The extension 16 may be attached to the support 11 of the extension module by elastic nesting, clipping. For this purpose, the support 11 of the picking module 10 may comprise a clipping relief such as a boss 17. Preferably, the support 11 of the picking module 10 may comprise a clipping relief for each side along the longitudinal direction Dl in order to mount an extension block longitudinally from each side. Additionally, also intended for mounting the extension block 16 on the picking module 10, the extension block 16 may comprise a hooking rod 18 intended to be inserted (preferably by elastic nesting) in one of the housings 15 formed in the support 11 of the picking module 10. In this case, the hooking rod 18 may be inserted in the end housing 15 formed in the support 11 of the picking module.

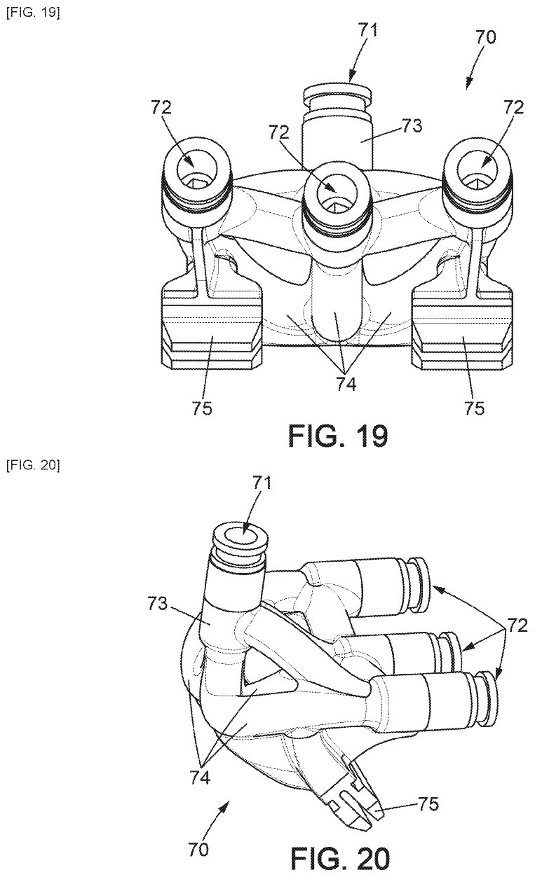

The modular picking assembly 40 may comprise one or more connectors 70. An example connector 70 can more specifically be seen in FIGS. 19 and 20. Each connector may comprise an inlet 71 with a fluid connection with a vacuum source and a plurality of outlets 72. Each outlet 72 of each connector 70 may have a fluid connection through an aspiration conduit with an associated upstream opening 21 among said one or more upstream openings 21 of an associated picking module 10 among said one or more picking modules 10.

It is understood that a plurality among said one or more picking modules 10 may be pneumatically connected to the same connectors 70 by multiple outlets 72. It is not excluded that two upstream openings 21 of a single picking module 10 be, respectively, pneumatically connected to two distinct connectors 70 among said one or more connectors 70.

There may be connectors 70 having different numbers of outlets 72 from each other. At least one, even each, of said one or more connectors 70 may comprise two outlets 72. At least one, even each, of said one or more connectors 70 may comprise three outlets 72. At least one, even each, of said one or more connectors 70 may comprise four outlets 72 or more.

Each connector 70 may be attached to the frame 41 by at least one of the following attachment techniques: riveting, bolting, adhering, welding, and clipping.

The inlet 71 of each connector 70 may have a fluid connection with the vacuum source via an aspiration conduit. Each aspiration conduit (meaning between vacuum source and connector 70 and between connector 70 and picking module 10) may be flexible.

Each connector 70 may be configured for providing an identical fluid path between the vacuum source and each upstream opening 21 associated with one of said one or more outlets 72 of the connector 70.

Each connector 70 may comprise a hollow body which comprises a collector 73 forming the inlet 71 and a plurality of arms 74 each forming an outlet 72. Each arm 74 may extend from the collector 73. Each arm 74 may have an identical length. It is understood here the real length measured along the trajectory followed by the arms 74 considering its curves. At least one, even each, of the arms 74 may have a curved or elbowed shape. Alternatively or additionally, at least one, even each, of the arms 74 may have a straight shape.

The modular picking assembly 40 may comprise an interface 80 suited for being coupled to a robotic arm. The interface may be mounted securely on the chassis 47. The robotic arm may be a polyarticulated arm, especially defining at least six axes of rotation and which is suited for moving and/or orienting the modular picking assembly 40 along six degrees of freedom. Thus, the modular picking assembly 40 may be moved between holding slender objects on the support surface 11 and the placement of slender objects in one or more packages. The robotic arm may be equipped with devices for recognition of shapes, sizes, etc. such as cameras so as to optimize the displacement and the production rate.

The vacuum source may be a vacuum pump such as a turbine pump or a vane pump, or a Venturi. The vacuum source is external to the picking device, for example, positioned on the robotic arm.

The invention therefore has several notable technical advantages which improve its effectiveness and its practicality in demanding industrial environments.

First, the hygienic aspect of the picking module is a major advantage. The materials used are compatible with sanitary standards, and the design avoids retention surfaces, which reduces the contamination risk. The parts are designed to allow an optimal flow of water during cleaning, and without screwing the maintenance is simplified while also maintaining high hygiene standards.

Another significant advantage is the possibility of disassembly without tools, because of the clipping system. With this mechanism, a module or an axis can be easily replaced, thus minimizing downtime and making maintenance easier. This characteristic is particularly beneficial in production environments where speed and effectiveness of interventions are crucial.

Finally, the invention provides a similar aspiration between the suction cups, because of the optimized shape of the conduit and the hole diameters of the suction cup supports. This uniformity in the aspiration guarantees a constant and reliable performance, improving the precision and effectiveness of the picking operations. These combined advantages make the invention a robust and adaptable solution for various industrial applications.

1. A picking module for a modular picking assembly, the picking module comprising:
a support
several lugs projecting from the support where each lug is made jointly with the support and suited for removable attachment of a respective suction cup;
at least one internal channel formed in the support and at least one part of one or more of the lugs, where the internal channel opens:
near one or more upstream openings located on the support and each configured for having a fluid connection with a respective aspiration conduit; and
near several downstream openings located at an end of a corresponding lug.

2. claim 2. The picking module according to claim 1, wherein the internal channel comprises:
a main conduit opening near said the several upstream openings; and
several secondary conduits with a fluid connection with the main conduit and each opening near one respective downstream opening.

3. A picking module according to claim 2, wherein the several lugs are distributed along a longitudinal direction of the picking module where the main conduit of the internal channel comprises at least one distribution branch extending longitudinally along the several lugs and through which the main conduit has a fluid connection with the several secondary conduits.

4. The picking module according to claim 1, wherein the one or more upstream openings comprise a single upstream opening.

5. claim 5. The picking module according to claim 1, which comprises one or more guiding members secured to the support, wherein each guiding member is configured for engaging with at least one respective rail in order to slidably guide the picking module on the rail.

6. The picking module according to claim 1, wherein the support comprises a number of downstream openings less than the number of lugs.

7. The picking module, according to claim 5, wherein at least one, or even each, of the one or more guiding members comprises a guiding fork which has a slit-shaped opening which allows the insertion and withdrawal of the rail in a tubular extension formed by the guiding fork, wherein the guiding fork is suited for holding the rail in the tubular extension by clipping effect.

8. A modular picking assembly comprising a frame which comprises one or more rails extending along an axial direction and one or more picking modules according to claim 1, wherein each picking module is slidably mounted on the one or more rails (42).

9. The modular picking assembly according to claim 8, wherein the picking modules are coupled pairwise so as to slide together on the one or more rails between a holding configuration and a placement configuration.

10. The modular picking assembly according to claim 8, which comprises one or more connectors which each comprises an inlet with a fluid connection with a vacuum source and a plurality of outlets, and wherein each outlet of each connector has a fluid connection through an aspiration conduit with an associated upstream opening among the one or more upstream openings of an associated picking module among the one or more picking modules.

11. The modular picking assembly according to claim 10, wherein each connector is configured for providing an identical fluid path between the vacuum source and each upstream opening associated with one of the one or more outlets of the connector.

12. A method for manufacturing a picking module according to claim 1, wherein the picking module is obtained by additive manufacturing.

13. A method for manufacturing a modular picking assembly according to claim 8, wherein the picking module is obtained by additive manufacturing.
